(19) United States
(12) Patent Application Publication
(10) Pub. No.: US 2014/0223255 A1
(43) Pub. Date: Aug. 7, 2014

(54) DECODER HAVING EARLY DECODING TERMINATION DETECTION

(71) Applicant: Western Digital Technologies, Inc., Irvine, CA (US)

(72) Inventors: GUANGMING LU, IRVINE, CA (US); JIMMY C. PU, CERRITOS, CA (US)

(21) Appl. No.: 13/918,400

(22) Filed: Jun. 14, 2013

Related U.S. Application Data
(63) Continuation-in-part of application No. 13/742,248, filed on Jan. 15, 2013.
(60) Provisional application No. 61/817,421, filed on Apr. 30, 2013.
(60) Provisional application No. 61/738,732, filed on Dec. 18, 2012.

(51) Int. Cl. G06F 11/10

(52) U.S. Cl. CPC G06F 11/1068
USPC 714/758

(57) ABSTRACT

Embodiments of decoders having early decoding termination detection are disclosed. The decoders can provide for flexible and scalable decoding and early termination detection, particularly when quasi-cyclic low-density parity-check code (QC-LDPC) decoding is used. In one embodiment, a controller iteratively decodes a data unit using a coding matrix comprising a plurality of layers. The controller terminates decoding the data unit in response to determining that the decoded data units from more than one layer decoding operation satisfy a parity check equation and that the decoded data units from more than one layer decoding operation are the same. Advantageously, the termination of decoding of the data unit can reduce a number of iterations performed to decode the data unit.

### CROSS REFERENCE TO RELATED APPLICATIONS

This application claims benefit to U.S. Provisional Patent Application No. 61/817,421 (Atty. Docket No. T6428.P) entitled “DECODER HAVING EARLY DECODING TERMINATION DETECTION” filed on Apr. 30, 2013, and is a continuation-in-part of U.S. patent application Ser. No. 13/742,248 (Atty. Docket No. T5896) entitled “DECODER HAVING EARLY DECODING TERMINATION DETECTION” filed on Jan. 15, 2013, which claims benefit to U.S. Provisional Patent Application No. 61/738,732 (Atty. Docket No. T5896.P) entitled “DECODER HAVING EARLY DECODING TERMINATION DETECTION” filed on Dec. 18, 2012; the disclosures of these applications are hereby incorporated by reference in their entirety.

### BACKGROUND

1. Technical Field

This disclosure relates to data storage systems for computer systems. More particularly, the disclosure relates to a decoder having early decoding termination detection.

2. Description of the Related Art

Non-volatile memory arrays often have limited endurance. The endurance of the memory array is typically contingent on usage pattern and wear. In addition, the endurance depends on a type of the non-volatile memory array used. For example, memory arrays with multi-level cell (MLC) NAND media typically have a lower endurance than memory arrays with single-level cell (SLC) NAND media. To protect user data stored to memory arrays from corruption, which may be caused by a diminished endurance, parity data can be generated and stored along with user data to facilitate error detection and/or correction. Decoding of parity data can be time consuming and resource intensive. Accordingly, it is desirable to provide more efficient mechanisms for decoding parity data.

### BRIEF DESCRIPTION OF THE DRAWINGS

Systems and methods that embody the various features of the invention will now be described with reference to the following drawings, in which:

FIG. 1 illustrates a combination of a host system and a data storage system that implements a decoder having early decoding termination detection according to one embodiment of the invention.

FIG. 2 illustrates a decoding matrix used for decoding data according to one embodiment of the invention.

FIG. 3 illustrates a block diagram of a decoder according to one embodiment of the invention.

FIG. 4 illustrates a block diagram of an early detection module according to one embodiment of the invention.

FIG. 5 is a state diagram illustrating a process of early termination detection according to one embodiment of the invention.

FIG. 6 is a timing diagram illustrating timings for a decoding process and an early termination detection process according to one embodiment of the invention.

FIG. 7 is a flow diagram illustrating a decoding process with early termination detection according to one embodiment of the invention.

FIGS. 8-10 illustrate block diagrams of early detection modules according to various embodiment of the invention.

### DETAILED DESCRIPTION

While certain embodiments are described, these embodiments are presented by way of example only, and are not intended to limit the scope of protection. Indeed, the novel methods and systems described herein may be embodied in a variety of other forms. Furthermore, various omissions, substitutions, and changes in the form of the methods and systems described herein may be made without departing from the scope of protection.

### Overview

Data storage systems, such as solid state drives, typically include one or more controllers coupled with one or more non-volatile memory arrays. Depending on the type of non-volatile memory array used, stored data may be subject to corruption as a result of, for example, read/write disturbs, loss of data retention, and/or loss of endurance. Data storage systems can utilize one or more error correction or error coding mechanisms to detect and/or correct errors in the stored data. One such mechanism can determine parity data, such as parity data, when writing user data. Parity data can be stored, for example, in a memory array. When stored user data is retrieved, parity data can be utilized as part of a decoding process to determine the integrity of the retrieved user data. If one or more errors are detected, such errors may be corrected.

Iterative decoding of data can involve considerable system overhead, such as processing time overhead, system resources overhead, and/or system components overhead (e.g., necessity to use additional hardware, firmware, etc.). Accordingly, ending iterative decoding early can provide significant power and/or processing time savings for data storage systems. Moreover, storing parity data (e.g., in a memory array) can reduce memory space available for storage of user data. It can thus also be advantageous for a data storage system to support different error code rates, code lengths, and/or different coding throughput speeds. For example, a data storage system can decode stored data having a relatively higher coding rate so that less parity data is used when a non-volatile memory is early in the lifecycle and thus has relatively higher retention and/or endurance. As non-volatile memory wears out over time, the data storage system can switch to decoding lower coding rates such that more parity data is generated to protect user data from errors. However, supporting multiple code rates, lengths, and/or throughput speeds can require adding and/or duplicating system components (hardware, firmware, etc.), which can increase power consumption and processing time.

Embodiments of the present invention are directed to a decoder having early decoding termination detection. In one embodiment, the decoder can perform early decoding termination detection while supporting multiple error code rates and/or error code lengths, by using nominal or no redundancy of system components. For example, an early detection module of the decoder can be configured so that the existing detection components can be used and/or reused for supporting various code rates and/or lengths. The early detection module can further support multiple error coding throughput speeds by, for example, utilizing parallel computation techniques. In other words, the architecture of the early detection module can be scalable and/or flexible. Accordingly, decoding efficiency and, consequently, data storage system performance can be increased without a substantial increase in the number and/or size of system components in data decoding. Moreover, power consumption and data processing time can be reduced by reducing the number of iterations for decoding data.

### System Overview

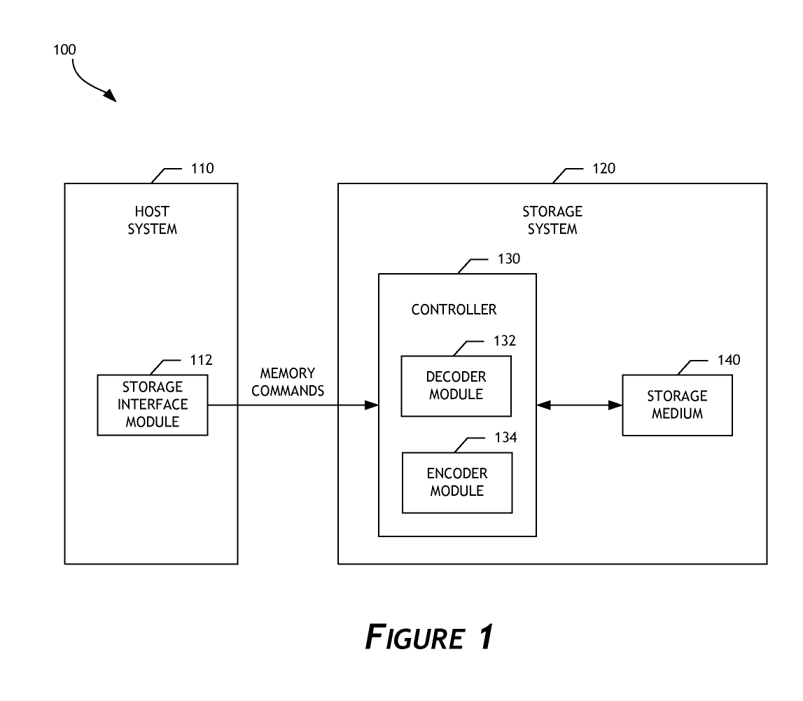

FIG. 1 illustrates a combination 100 of a host system 110 and a data storage system 120 that implements a decoder having early decoding termination detection according to one embodiment of the invention. As is shown, the data storage system 120 (e.g., hybrid hard drive, solid state drive, etc.) includes a controller 130 and a storage medium 140. The storage medium 140 may comprise an array of non-volatile memory, such as flash integrated circuits, Chalcogenide RAM (C-RAM), Phase Change Memory (PC-RAM or PRAM), Programmable Metallization Cell RAM (PMC-RAM or PMCm), Ovonic Unified Memory (OUM), Resistance RAM (RRAM), NAND memory (e.g., single-level cell (SLC) memory, multi-level cell (MLC) memory, or any combination thereof), NOR memory, EEPROM, Ferroelectric Memory (FeRAM), Magnetoresistive RAM (MRAM), other discrete NVM (non-volatile memory) chips, or any combination thereof. In some embodiments, the data storage system 120 can further comprise other types of storage, such as one or more magnetic media storage modules or other types of storage modules.

The controller 130 can be configured to receive data and/or storage access commands from a storage interface module 112 (e.g., a device driver) of the host system 110. Storage access commands communicated by the storage interface module 112 can include write data and read data commands issued by the host system 110. Read and write commands can specify a logical address (e.g., logical block addresses or LBAs) used to access the data storage system 120. The controller 130 can execute the received commands in the storage medium 140.

Data storage system 120 can store data communicated by the host system 110. In other words, the data storage system 120 can act as memory storage for the host system 110. To facilitate this function, the controller 130 can implement a logical interface. The logical interface can present to the host system 110 data storage system memory as a set of logical addresses (e.g., contiguous address) where user data can be stored. Internally, the controller 130 can map logical addresses to various physical locations or addresses in the storage medium 140 and/or other storage modules.

The controller 130 includes a decoder module 132 and an encoder module 134 configured to decode and encode data, respectively, stored in and retrieved from the storage medium 140. The decoder module 132 can further determine integrity of data retrieved from the storage medium 140 and perform, if necessary, error correction of retrieved data. In some embodiments, when the storage medium 140 is early in the lifecycle and thus has relatively higher retention and/or endurance, the controller 130 can direct the encoder module 134 to encode data using a relatively higher coding rate so that less parity data is used. As the storage medium 140 wears out over time, the controller 130 can direct the encoder module 134 to switch to lower encoding rates such that more parity data is generated to protect user data from errors. The controller 130 can store the coding rates for encoded data in the storage medium 140 or another storage module (not shown) so that the decoder module 132 can later access the information to decode the encoded data.

### Overview of Low-Density Parity-Check (LDPC) Coding

In one embodiment, the decoder module 132 and the encoder module 134 can utilize low-density parity-check (LDPC) codes for decoding and/or generating parity data, respectively. LDPC codes can be decoded using a decoding matrix H and generated using a corresponding generating matrix G.

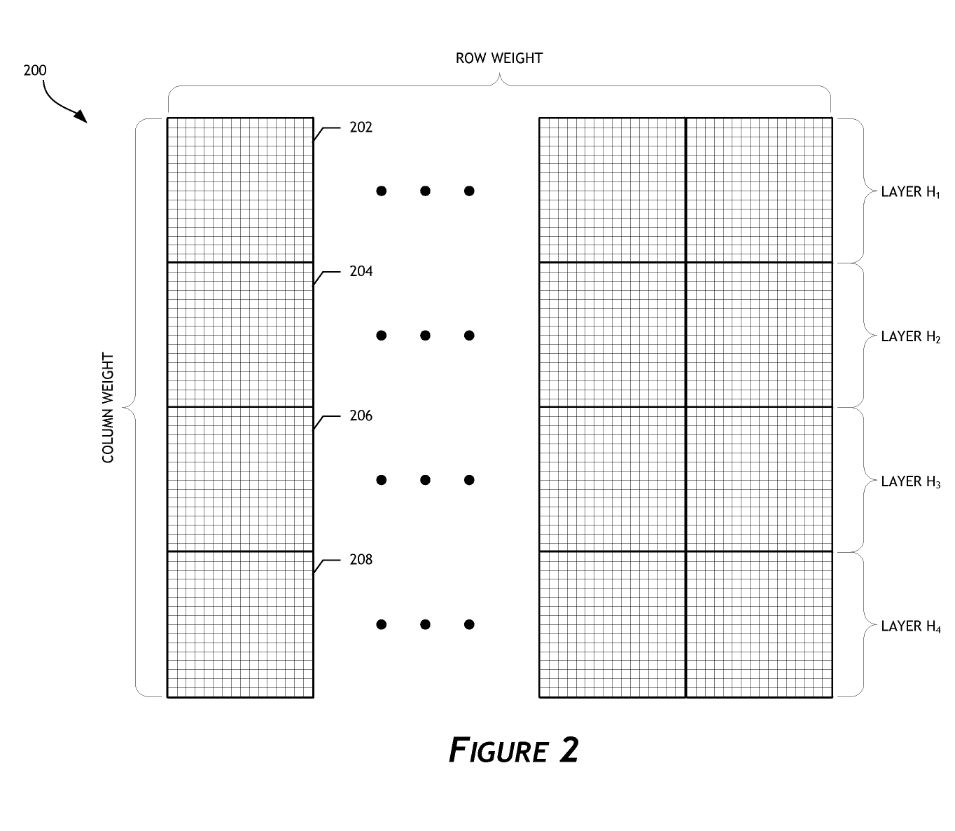

FIG. 2 illustrates a decoding matrix 200 used for decoding data according to one embodiment of the invention. The decoding matrix 200 represents an example decoding matrix H, which has a column weight of four as H is a quasi-cyclic (QC) LDPC matrix (i.e., four layers, which may be referred to as layers H₁, H₂, H₃, and H₄) and includes multiple sub-matrixes, such as sub-matrixes 202, 204, 206, and 208, which may be termed P sub-matrixes. The column weight may vary if other types of H matrixes are used. The multiple sub-matrixes may each have a size of P bits×P bits. P may be an integer value, for example, such as 128, 256, 350, 512, 1024, etc. The multiple sub-matrixes can be identity matrixes rotated by values where each row of one sub-matrix is shifted or rotated by the same number of columns (e.g., each sub-matrix can be a circulant matrix). The decoding matrix 200 further has a row weight. The row weight can equal the number of sub-matrixes per layer in the case of a QC-LDPC matrix. Other cases may have a different row weight depending on the type of matrixes used. In some embodiments, the decoding matrix 200 may not include a NULL sub-matrix. Although the decoding matrix 200 is illustrated with a column weight equal to four, in some embodiments, the decoding matrix 200 can have a column weight less than or greater than four, such as a column weight equal to three or five, for example. Each different decoding matrix size can correspond to and enable decoding of data units having different amounts of parity.

The decoding matrix 200 can be used in layered, iterative quasi-cyclic LDPC decoding where a layered approach or layer decoding operations are used to decode data retrieved from a storage medium. The retrieved data can be input to a decoder, such as the decoder module 132, in portions having a length equal to one of multiple code word lengths. The row weight of the decoding matrix can equal the code word length for encoded data in terms of a number of sub-matrixes in the decoding matrix. By changing the P sub-matrix size or column weight of the decoding matrix used to decode data, data having different code rates can be decoded. By changing the row weight of the decoding matrix used to decode data, data for different memory page formats can be coded. In some embodiments, the code word length used to decode data can depend on an E-page size (e.g., an error correcting code page size or a defined grouping of memory for a non-volatile memory array) or NAND flash page size of a memory of a data storage system, such as the data storage system 120.

The decoding matrix 200 can be used in solving a minimum-sum (min-sum) algorithm. As part of the min-sum algorithm, Rₘⱼ may be defined to denote a check node log-likelihood ratio (LLR) message sent from a check node m to a variable node j. L(qₘⱼ) may be defined to denote a variable node LLR message sent from the variable node j to the check node m. L(qⱼ) (j=1, . . . , N) may be defined to represent the a posteriori probability ratio (APP messages) for the variable nodes. The APP messages can be initialized with the corresponding a priori (channel) reliability value of the coded bit j. For each variable node j of a current horizontal layer of the decoding matrix 200, messages L(qₘⱼ) that correspond to a particular check equation m are computed according to Equation 1.

L(qₘⱼ)=L(qⱼ)−Rₘⱼ (1)

For each check node m, message Rₘⱼ, which can correspond to all variable nodes j that participate in a parity check equation, can be computed according to Equation 2.

Rₘⱼ≈Π_{jεN(m)\{j}}sign(L(qmj′))×(min_{jεN(m)\{j}}|L(qmj′)|) (2)

The a posteriori probability APP messages in the current horizontal layer can be updated according to Equation 3.

L(qⱼ)=L(qₘⱼ)+Rₘⱼ (3)

A decision can be made after processing each horizontal layer of the decoding matrix 200 based on the sign of L(q), j=1, . . . , N. If all parity check equations are satisfied, the decoding algorithm may stop. Otherwise, the min-sum algorithm of Equations 1, 2, and 3 can be repeated for a next horizontal layer.

In some embodiments, the parity check equation used to determine whether data was successfully decoded using one horizontal layer of the decoding matrix 200 can be Equation 4.

C·Hₙ^{T}=0 (4)

Equation 4 includes a matrix multiplication of a data portion or code word C and a transpose of the one horizontal layer Hₙ of the decoding matrix 200. The parity check of Equation 4 can be satisfied when the result of the matrix modification is zero, and thus the data portion C may have been successfully decoded using the one horizontal layer Hₙ when the result is zero.

The decoding matrix 200 can be further used in iteratively solving the min-sum algorithm. The decoding algorithm can be performed once for all layers of the decoding matrix 200 (e.g., one iteration of the decoding algorithm can be performed). If one or more parity check equations are not satisfied for at least one layer, the decoding algorithm can be performed again (e.g., another iteration of the decoding algorithm can be performed). Additionally or alternatively, the decoding algorithm can be performed for consecutively processed layers of the decoding matrix 200 (e.g., some layers of one iteration and some layers of another iteration, or all layers of one iteration). If (1) one or more parity check equations are not satisfied for at least one layer of the consecutively processed layers or (2) the code word C changed during processing of the corresponding consecutively processed layers, the decoding algorithm can be performed again. Further, the decoding algorithm can additionally or alternatively be performed until a predetermined maximum number of iterations is reached. The maximum number of iterations may be determined based on a number of iterations historically used to successfully decode data, a desired throughput, or power constraints, for instance.

### Decoder Having Early Decoding Termination Detection

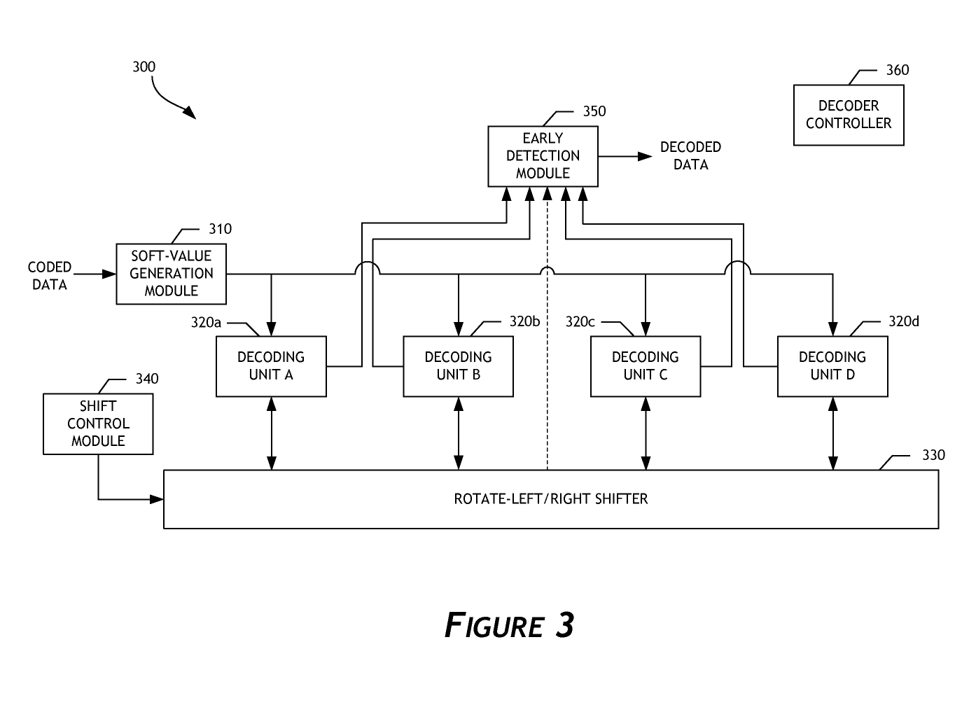

FIG. 3 illustrates a block diagram of a decoder 300 according to one embodiment of the invention. The decoder 300 can be a quasi-cyclic decoder, such as a quasi-cyclic low-density parity check (LDPC) decoder. The decoder 300 may correspond to the decoder module 132 of FIG. 1. The decoder 300 includes a decoder controller 360 that can manage operations of components of the decoder 300, as well as data exchange and iteration control. In some embodiments, the decoder controller 360 may be a separate lower-level controller from the controller 130 of FIG. 1. In other embodiments, the decoder controller 360 can be a part of the controller 130.

The decoder 300 includes a soft-value generation module 310 and multiple decoding units, including decoding unit A 320a, decoding unit B 320b, decoding unit C 320c, and decoding unit D 320d (collectively, decoding units 320). The soft-value generation module 310 can receive coded data retrieved from a storage medium and generate soft values (e.g., log-likelihood values or scaled values) as inputs for the decoding units 320. In some embodiments, the soft-value generation module 310 constructs soft values by reading the same memory page multiple times with different conditions (e.g., an adjusted voltage read threshold). The multiple read results can be combined in such a way that a final fixed-point represents a probability of 1 or 0. Further, in some embodiments, the soft-value generation module 310 can additionally or alternatively provide binary inputs to the decoding units 320. The soft-value generation module 310 may input data units having one of multiple code word lengths to the decoding units 320 for processing. Each decoding unit may include one or more memories (not shown) for storing a portion of or the entire data unit received from the soft-value generation module 310.

The decoding units 320 can be configured to iteratively decode data units according to a min-sum algorithm, such as based on Equations 1, 2, and 3. The decoding units 320 can decode data units that are encoded using one of multiple code word lengths or processing unit lengths. The decoding units 320 can operate in conjunction with rotate-left/right shifter 330 and the shift control module 340 to perform layer decoding operations using one of multiple decoding matrixes, such as the decoding matrix 200. After decoding using each layer or performing each layer decoding operation, the decoding units 320 can determine a minimum calculated value for each layer from the min-sum algorithm to determine a global minimum (e.g., a minimum of the minimums) for each layer. The global minimums for the layers can then be compared to determine a lowest or global minimum for all layers. The decoding units 320 can include one or more working memories (not shown) to store minimum calculated values or data during the decoding process, for example.

The decoding units 320 can be configured to decode subsets of a data unit in parallel or substantially in parallel using subsets of a corresponding decoding matrix. In some embodiments, the decoding units 320 can each have a processing capacity of soft values or bits per clock cycle corresponding to the size of a smallest P sub-matrix size of a decoding matrix that is supported by the decoder 300. For example, the decoding units 320 can each process 256 soft values, 512 soft values, or 1024 soft values subsets of the data unit per clock cycle when the size of the smallest P sub-matrix size supported is 256 bits×256 bits, 512 bits×512 bits, or 1024 bits×1024 bits, respectively. The decoding units 320 may share values determined as part of a layer decoding operation, such as local determined minimums from decoding subsets of one layer of a data unit, to facilitate the parallel decoding and determining of a minimum calculated value for each layer. In some embodiments, one or more of the decoding units 320 share values when processing a data unit having one length and not another length.

The rotate-left/right shifter 330 can be configured to shift or rotate (e.g., to the left or the right) soft values or bits of portions of data units according to instructions from the shift control module 340. The shift control module 340 can determine or look-up a corresponding decoding matrix from a memory (not shown) for decoding particular data units. Based on the corresponding decoding matrix, the shift control module 340 can direct the rotate-left/right shifter 330 to process data units using a particular granularity and shift portions of data units an amount based on the size and contents of sub-matrixes of a decoding matrix used to decode data units (e.g., a P sub-matrix size and rotation of an identity matrix). In some embodiments, the rotate-left/right shifter 330 can be a configurable Benes network or group of shift registers, and the rotate-left/right shifter 330 may support input data sizes of at least 256 soft values, 512 soft values, and 1024 soft values, for instance. In such embodiments, the Benes network can further include one or more smaller Benes networks connected to one another so as to function as a larger Benes network. In some example operations of the rotate-left/right shifter 330, the rotate-left/right shifter 330 can shift data unit portions having a size of 256 soft values, 512 soft values, or 1024 soft values. In a simple, illustrative example operation of the rotate-left/right shifter 330 shown below, the rotate-left/right shifter 330 can shift each row of a 1 bit×6 bits matrix one column to the right based on the contents of a sub-matrix of the decoding matrix.

$$[ \begin{matrix}{b}_{1} & {b}_{2} & {b}_{3} & {b}_{4} & {b}_{5} & {b}_{6}\end{matrix} ] {\to }^{group of 6 values ( shift right 1 position )} [ \begin{matrix}{b}_{6} & {b}_{1} & {b}_{2} & {b}_{3} & {b}_{4} & {b}_{5}\end{matrix} ]$$

The rotate-left/right shifter 330 can shift data unit portions having different sizes or granularities corresponding to a decoding matrix sub-matrix size although the rotate-left/right shifter 330 may have a fixed capacity per clock cycle. The shift control module 340 may direct the rotate-left/right shifter 330 to consider different portions of data processed by the rotate-left/right shifter 330 as different rotation units. Thereby, the shift control module 340 can direct the shifting of different portions of the data independently. In another simple, illustrative example operation of the rotate-left/right shifter 330 shown below, the rotate-left/right shifter 330 can independently shift two 1 bit×3 bits matrixes one column to the right based on the contents of two sub-matrixes of the decoding matrix.

$$[ \begin{matrix}{b}_{1} & {b}_{2} & {b}_{3} & {b}_{4} & {b}_{5} & {b}_{6}\end{matrix} ] {\to }^{group of 3 values ( shift right 1 position , shift right 2 positions )} [ \begin{matrix}{b}_{3} & {b}_{1} & {b}_{2} & {b}_{5} & {b}_{6} & {b}_{4}\end{matrix} ]$$

The decoding units 320 can output results, such as decoded data, from one or more layer decoding operations to an early detection module 350. The early detection module 350 can determine whether to terminate further iterations of decoding the data unit based at least in part on whether a parity check equation, such as the parity check of Equation 4, is satisfied by the results and one or more layers of the decoding matrix. The early detection module 350 can operate in parallel or substantially in parallel with the decoding units 320 to stop decoding by the decoding units 320. The parity check equations may be evaluated while decoded data is in a rotated order other than an original order of the data before it was encoded. In addition, the early detection module 350 can be used to rotate decoded data back to the original order of the data before it was encoded. In some embodiments, the early detection module 350 can include one or more early detection sub-modules where each sub-module can process the results and one layer of the decoding matrix in parallel or substantially in parallel.

In some embodiments, a number of decoding units and/or early detection sub-modules can be selected in accordance with a desired throughput. For example, the number of decoder units can be 1, 2, 3, or 4 (as illustrated in FIG. 3), and so on. Similarly, the number of early detection sub-modules can be 1 (as illustrated in FIG. 3), 2, 3, or 4, and so on. In one embodiment, the upper limit on the number of decoder units and/or early detection sub-modules can be selected as the number of sub-matrixes in one or more decoding matrixes which are supported by one or more of the decoding units 320, the rotate-left/right shifter 330, or the early detection module 350. Moreover, in some embodiments, the rotate-left/right shifter 330 can output shifted data unit portions to the early detection module 350 to facilitate earlier termination detection by the early detection module 350.

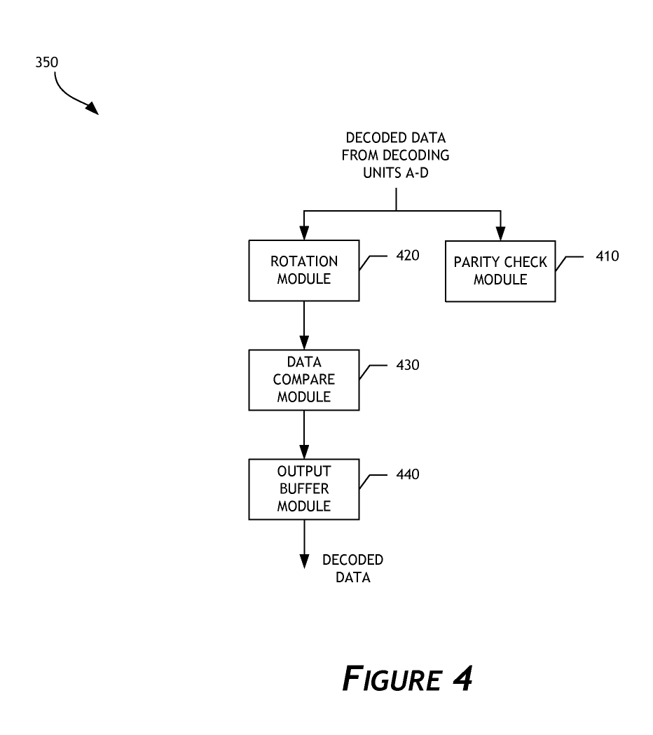

FIG. 4 illustrates a block diagram of the early detection module 350 of FIG. 3 according to one embodiment of the invention. The early detection module 350 can include a parity check module 410, a rotation module 420, a data compare module 430, and an output buffer module 440. The early detection module 350 can perform early termination detection based on the results of one or more layer decoding operations or each layer decoding operation using the decoding matrix. As a result, the early detection module 350 can stop decoding the data unit after one or more layer decoding operations and may advantageously enable early termination of decoding of data once the data unit may have successfully been decoded or decoded with a threshold degree of confidence (e.g., 50%, 75%, 90%, 99%, or 99.99% confidence, or the like). The termination of the decoding can reduce number of layer decoding operations and iterations performed to decode the data.

The parity check module 410 can receive decoded data from the decoding units 320 of FIG. 3 and perform an exclusive-or operation for the decoded data. Based on the results of the exclusive-or operation, the parity check module 410 can, for instance, set a flag configured to provide an indication of whether decoded data and a layer of the decoding matrix satisfy a parity check equation, such as Equation 4. The flag can be used by one or more other components of the early detection module 350 to determine whether the decoded data may be successfully decoded or decoded with a certain degree of confidence and whether to terminate decoding of the data unit.

In one example, the parity check module 410 may have a capacity of 1 bit×1024 bits and operate using the following pseudocode when processing a decoding matrix that includes sub-matrixes having a size of 256 bits×256 bits. The parity check module 410 can process four 1 bit×256 bits portions of decoded data per clock cycle in this example.

Flag = 0;
For(i=0; i<256; i++)
{ Flag = Flag OR (Bit[i] \hat{ } Bit[i+256] \hat{ } Bit[i+512] \hat{ } Bit[i+768]); }

In another example, the parity check module 410 may have a capacity of 1 bit×1024 bits and operate using the following pseudocode when processing a decoding matrix that includes sub-matrixes having a size of 512 bits×512 bits. The parity check module 410 can process two 1 bit×512 bits portions of decoded data per clock cycle in this example.

Flag = 0;
For(i=0; i<512; i++)
{ Flag = Flag OR (Bit[i] \hat{ } Bit[i+512]); }

In yet another example, the parity check module 410 may have a capacity of 1 bit×1024 bits and operate using the following pseudocode when processing a decoding matrix that includes sub-matrixes having a size of 1024 bits×1024 bits. The parity check module 410 can process one 1 bit×1024 bits portions of decoded data per clock cycle in this example.

Flag = 0;
For(i=0; i<1024; i++)
{ Flag = Flag OR (Bit[i]); }

The rotation module 420 can receive decoded data from the decoding units 320 of FIG. 3. Since the received decoded data may be rotated in an order based on a particular layer of decoding with the decoding matrix, the rotation module 420, under the control of the shift control module 340, can rotate or align the received data portions for evaluation by the data compare module 430. The rotation module 420 can function similarly to the rotate-left/right shifter 330 of FIG. 3. The rotation module 420 can be configured to shift or rotate the portions according to instructions from the shift control module 340. The shift control module 340 can determine or look-up a corresponding decoding matrix from a memory (not shown) that was used for decoding the data. Based on the corresponding decoding matrix, the shift control module 340 can direct the rotation module 420 to process data using a particular granularity and shift portions of the data an amount based on the size and contents of sub-matrixes of a decoding matrix used to decode the data. In some embodiments, the rotation module 420 can be a configurable Benes network or group of shift registers, and the rotation module 420 may support input matrix sizes of at least 1 bit×256 bits, 1 bit×512 bits, and 1 bit×1024 bits, for instance. In such embodiments, the Benes network can further include one or more smaller Benes networks connected to one another so as to function as a larger Benes network. Further, the rotation module 420 can rotate portions of data by amounts based on a comparison between a rotation of a current layer relative to a previous layer. In one example operation of the rotation module 420, the rotation module 420 can shift data portions having a size of 1 bit×256 bits, 1 bit×512 bits, or 1 bit×1024 bits.

The rotation module 420 can shift data portions having different sizes or granularities corresponding to a decoding matrix sub-matrix size although the rotation module 420 may have a fixed capacity per clock cycle. The shift control module 340 may direct the rotation module 420 to consider different portions of data processed by the rotation module 420 as different rotation units. Thereby, the shift control module 340 can direct the shifting of different portions of the data independently as discussed with respect to the rotate-left/right shifter 330. In some embodiments, the shift control function performed by the shift control module 340 of the early detection module 350 of FIG. 4 is performed by a shift controller other than the shift control module 340 of the decoder 300 of FIG. 3.

The data compare module 430 can receive, store, and compare the shifted decoded data from two or more different layer decoding operations. By comparing the shifted decoded data, the data compare module 430 can determine whether the decoded data from the two or more layer decoding operations are the same or different from one another. When the decoded data from the layer decoding operations are the same, the data compare module 430 can set one or more flags useable to determine whether the decoded data may be successfully decoded or decoded with a certain degree of confidence. The early detection module 350 can thereby determine to terminate decoding of the data early based at least in part on the result of the comparison by the data compare module 430.

The data compare module 430 can output shifted decoded data to the output buffer module 440. The output buffer module 440, in turn, can store and output the decoded data for processing, such as for shortening, re-aligning, or storing to other memory.

In some embodiments, the data compare module 430 can make the early termination decision for the early detection module 350 and selectively output decoded data to the output buffer module 440. For example, the data compare module 430 can determine to terminate decoding and output decoded data to the output buffer module 440 when (1) the parity check module 410 determines that decoded data and one or more layers of the decoding matrix satisfy a parity check equation and (2) the data compare module 430 determines that decoded data from two or more layer decoding operations are the same. In such cases, the data compare module 430 can indicate to the decoding units 320 to terminate decoding of the data unit and to begin decoding of a next data unit by setting one or more flags. Further, the parity check module 410 or the data compare module 430 can maintain a running count of a number of consecutive times that one or more determinations are satisfied in order to facilitate determining when to terminate decoding of the data unit.

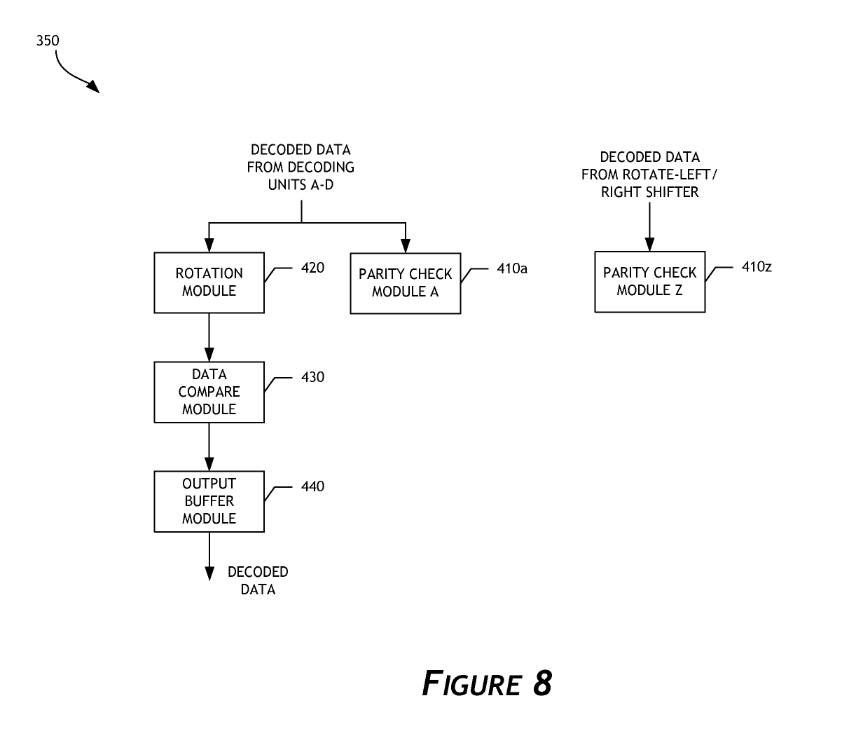

Although not illustrated in FIG. 4, one or more additional parity check modules, such as the parity check module 410, or rotation modules, such as the rotation module 420, can be included in the early detection module 350. The additional modules can facilitate parallel processing of decoded data by the early detection module 350 at the cost of additional software and/or hardware. Some examples of early detection modules that include one or more additional modules are discussed in more detail with respect to FIGS. 8-10.

### Early Decoding Termination Detection Processes

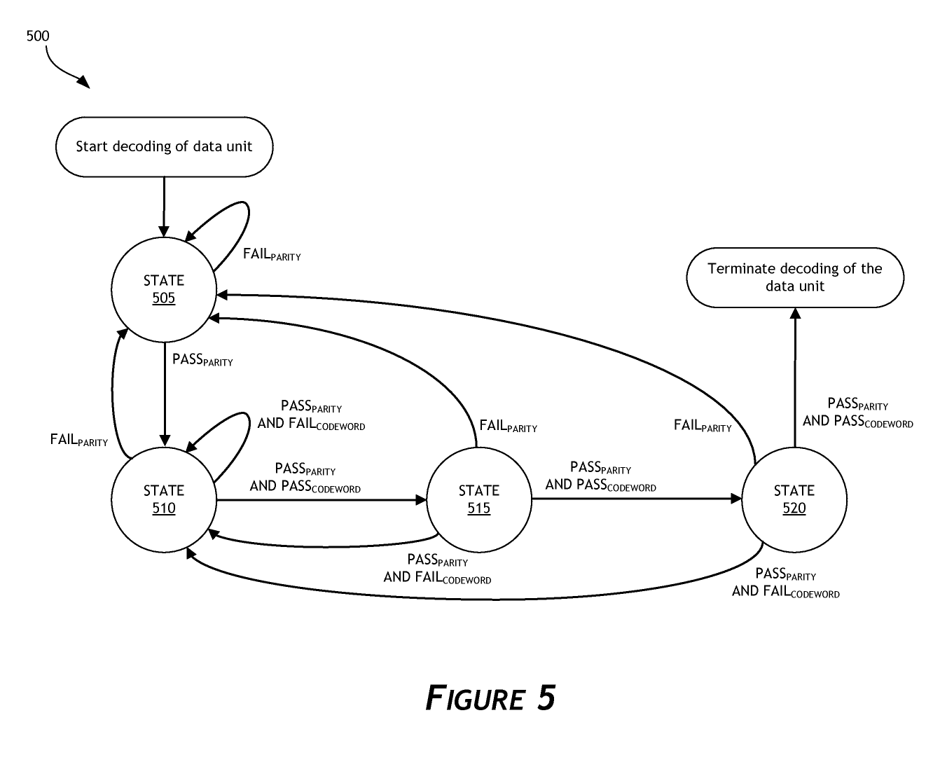

FIG. 5 is a state diagram illustrating a process 500 of early termination detection according to one embodiment of the invention. The process 500 illustrates an early termination detection process for a decoding matrix with four layers, such as the decoding matrix 200 of FIG. 2, and one example set of early termination detection conditions, including whether (1) a parity check is satisfied for x number of consecutive layer decoding operations and (2) a decoded data unit or code word remains unchanged for x-1 consecutive layer decoding operations, where x is a total number of layers of the decoding matrix. In some embodiments, the controller 130 and/or decoder module 132 of FIG. 1 are configured to perform the process 500. More particularly, the early detection module 350 of FIG. 4 can be configured to perform the process 500.

At state 505, the process 500 determines whether a decoded data unit from one layer decoding operation and a corresponding layer of a decoding matrix satisfy a parity check equation, such as Equation 4. The corresponding layer of the decoding matrix can be the layer of the decoding matrix used to decode the data unit during the one layer decoding operation. When the parity check equation is not satisfied (indicated as FAIL_{PARITY} in FIG. 5), the process 500 returns to state 505. On the other hand, when the parity check equation is satisfied (indicated as PASS_{PARITY} in FIG. 5), the process 500 moves to state 510.

At state 510, the process 500 determines whether a decoded data unit from a next layer decoding operation and a corresponding next layer of a decoding matrix satisfy a parity check equation, such as Equation 4, as well as whether the decoded data unit is the same as the decoded data unit from the previous layer decoding operation. The next layer decoding operation may or may not be from the same iteration of decoding the data unit using the decoding matrix. When the parity check equation is not satisfied, the process 500 moves to state 505. When the parity check equation is satisfied and the decoded data unit is not the same as the decoded data unit from the previous layer decoding operation (indicated as PASS_{PARITY} AND FAIL_{CODEWORD} in FIG. 5), the process 500 returns to state 510. When the parity check equation is satisfied and the decoded data unit is the same as the decoded data unit from the previous layer decoding operation (indicated as PASS_{PARITY} AND PASS_{CODEWORD} in FIG. 5), the process 500 moves to state 515.

At state 515, the process 500 determines whether a decoded data unit from another next layer decoding operation and a corresponding another next layer of a decoding matrix satisfy a parity check equation, such as Equation 4, as well as whether the decoded data unit is the same as the decoded data unit from the previous layer decoding operation. The another next layer decoding operation may or may not be from the same iteration of decoding the data unit using the decoding matrix as one or more previous layer decoding operations. When the parity check equation is not satisfied, the process 500 moves to state 505. When the parity check equation is satisfied and the decoded data unit is not the same as the decoded data unit from the previous layer decoding operation, the process 500 moves to state 510. When the parity check equation is satisfied and the decoded data unit is the same as the decoded data unit from the previous layer decoding operation, the process 500 moves to state 520.

At state 520, the process 500 determines whether a decoded data unit from a following next layer decoding operation and a corresponding following next layer of a decoding matrix satisfy a parity check equation, such as Equation 4, as well as whether the decoded data unit is the same as the decoded data unit from the previous layer decoding operation. The following next layer decoding operation may or may not be from the same iteration of decoding the data unit using the decoding matrix as one or more previous layer decoding operations. When the parity check equation is not satisfied, the process 500 moves to state 505. When the parity check equation is satisfied and the decoded data unit is not the same as the decoded data unit from the previous layer decoding operation, the process 500 moves to state 510. When the parity check equation is satisfied and the decoded data unit is the same as the decoded data unit from the previous layer decoding operation, the process 500 ends and decoding of the data unit can be terminated.

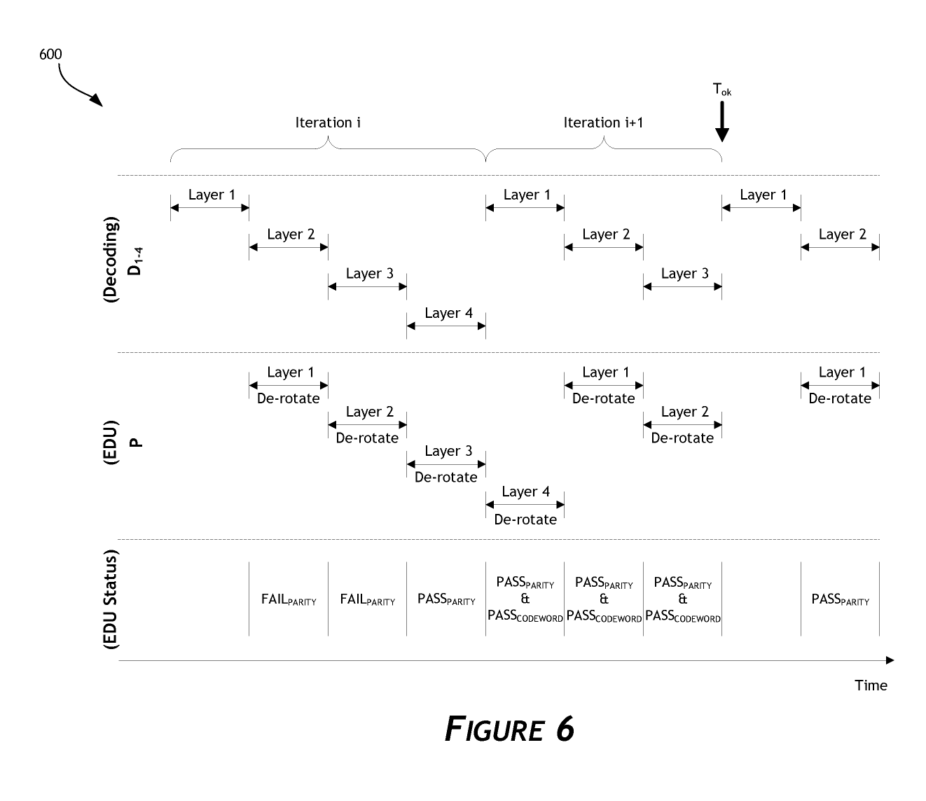

FIG. 6 is a timing diagram 600 illustrating timings for a decoding process and an early termination detection process according to one embodiment of the invention. The timing diagram 600 illustrates decoding and early termination detection using a decoding matrix H having four layers. The portion of the timing diagram 600 labeled as Decoding D₁₋₄ corresponds to decoding operations performed by decoding units, such as the decoding units 320 of FIG. 3. The portion of the timing diagram 600 labeled as EDU (early detection unit) P corresponds to early decoding termination detection performed by a parity check module, such as the parity check module 410 of FIG. 4. The portion of the timing diagram 600 labeled as EDU Status corresponds to the early decoding termination detection results for a parity check equation and a change in decoded data unit for a particular layer decoding operation. In some embodiments, the controller 130 and/or decoder module 132 of FIG. 1 are configured to perform a process according to the timing diagram 600. More particularly, the early detection module 350 of FIG. 4 can be configured to perform a process according to the timing diagram 600.

The early detection unit can be configured to determine, for each layer decoding operation, whether (1) a parity check equation, such as Equation 4, is satisfied for the layer decoding operation and (2) the decoded data unit has not changed from the decoded data unit of the previous layer decoding operation. In some embodiments, when both conditions (1) and (2) are satisfied, the early detection unit can increment a counter to track satisfactions of the conditions (1) and (2). When one or both conditions are not satisfied, the early detection unit can set the counter to one or zero. If the counter reaches a threshold count value, the counter can thereby indicate that the data was successfully decoded or decoded with a threshold degree of confidence, and decoding of the data unit can stop and decoding of another data unit can begin. Although the use of a counter is illustrated with respect to the discussion of FIG. 5, one or more other approaches can be used to track satisfaction determinations in other embodiments.

The timing diagram 600 illustrates at least iterations i and i+1 of decoding a data unit. The decoding iteration i begins by performing one layer decoding operation of decoding the data unit using Layer 1 of the decoding matrix H to generate a decoded data unit C_{(i,1)}. Subsequently, the iteration i continues with individually, consecutively decoding of the data unit using Layers 2, 3, and 4. After completion of the iteration i, a next iteration i+1 of decoding the data unit begins.

Substantially in parallel with decoding the data unit using Layer 2 during iteration i to generate a decoded data unit C_{(i,2)}, early decoding termination detection begins with evaluating the decoded data unit C_{(i,1)} and Layer 1. The parity check equation in the illustrated case is not satisfied, however, for Layer 1 (e.g., C_{(i,1)}·H₁^{T}≠0), and the early decoding termination detection process continues and a counter can be set to zero. Substantially in parallel with decoding the data unit using Layer 3 during iteration i to generate a decoded data unit C_{(i,3)} the early decoding termination detection continues with evaluating the decoded data unit C_{(i,2)} and Layer 2. The parity check equation in this case is also not satisfied for Layer 2 (e.g., C_{(i,2)}·H₂^{T}≠0), so the early decoding termination detection process continues and the counter can remain set to zero.

Continuing the example of the previous paragraph, substantially in parallel with decoding the data unit using Layer 4 during iteration i to generate a decoded data unit C_{(i,4)} the early decoding termination detection continues with evaluating the decoded data unit C_{(i,3)} and Layer 3. The parity check equation in this case is satisfied for the early decoding termination detection for Layer 3 (e.g., C_{(i,3)}·H₃^{T}=0), so the early decoding termination detection process continues and the counter can be incremented to one. Substantially in parallel with decoding the data unit using Layer 1 during iteration i+1 to generate a decoded data unit C_{(i+1,1)} the early decoding termination detection continues with evaluating the decoded data unit C_{(i,4)} and Layer 4. The parity check equation in this case is satisfied for the early decoding termination detection for Layer 4 (e.g., C_{(i,4)}·H₄^{T}=0) and the decoded data unit has not changed from the decoded data unit of the previous layer decoding operation (e.g., C_{(i,3)}=C_{(i,4)}, so the early decoding termination detection process continues and the counter can be incremented to two. Substantially in parallel with decoding the data unit using Layer 2 during iteration i+1 to generate a decoded data unit C_{(i+1,2)} the early decoding termination detection continues with evaluating the decoded data unit C_{(i+1,1)} and Layer 1. The parity check equation in this case is satisfied for the early decoding termination detection for Layer 1 (e.g., C_{(i+1,1)}·H₁^{T}=0) and the decoded data unit has not changed from the decoded data unit of the previous layer decoding operation (e.g., C_{(i,4)}=C_{(i+1,1)}), so the early decoding termination detection process continues and the counter can be incremented to three. Substantially in parallel with decoding the data unit using Layer 3 during iteration i+1 to generate a decoded data unit C_{(i+1,3)} the early decoding termination detection continues with evaluating the decoded data unit C_{(i+1,2)} and Layer 2. The parity check equation in this case is satisfied for the early decoding termination detection for Layer 2 (e.g., C_{(i+1,2)}·H₂^{T}=0) and the decoded data unit has not changed from the decoded data unit of the previous layer decoding operation (e.g., C_{(i+1,1)}=C_{(i+1,2)}), so the counter can be incremented to four. In some embodiments, because the counter stores the value of four and the decoding coding H matrix has four layers, the decoded data unit can be determined to be successfully decoded at time Tₒₖ. Thus, another data unit can next be decoded using Layer 1 of the same or a different decoding matrix.

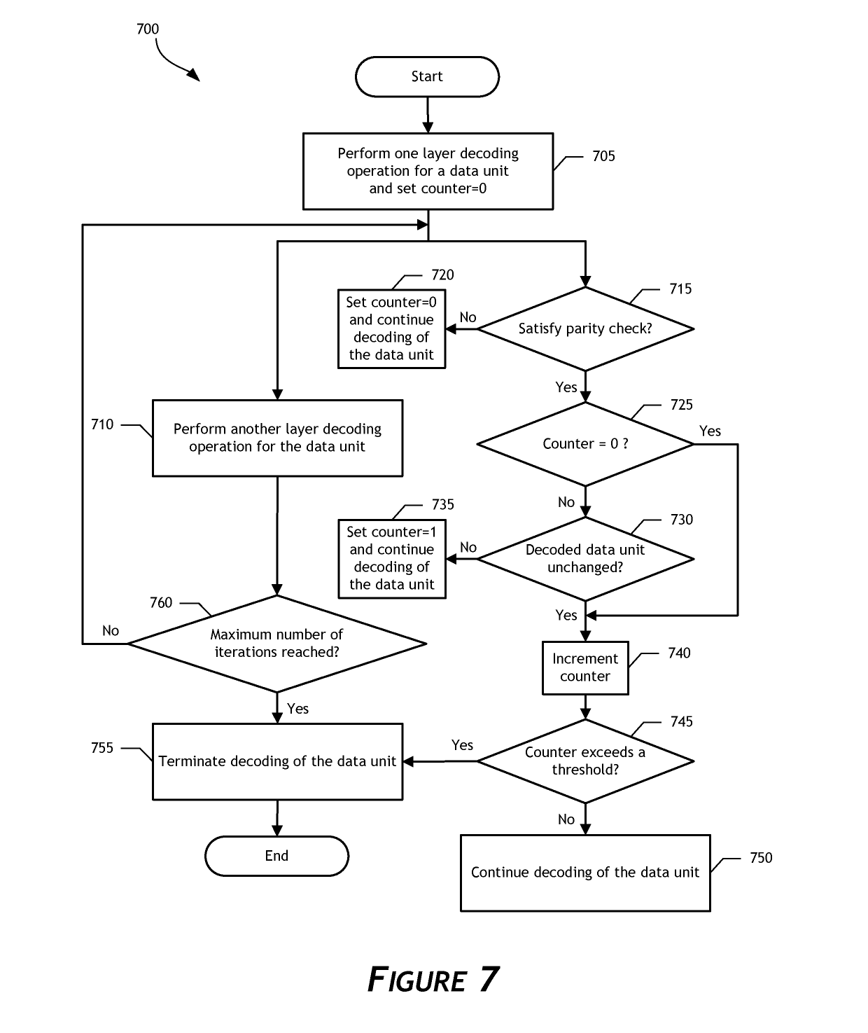

FIG. 7 is a flow diagram illustrating a decoding process 700 with early termination detection according to one embodiment of the invention. In some embodiments, the controller 130 and/or decoder module 132 of FIG. 1 are configured to perform the process 700. More particularly, the early detection module 350 of FIGS. 4 and 8-10 can be configured to perform the process 700.

At block 705, the process 700 performs one layer decoding operation of decoding a data unit and sets a counter to zero. For example, the decoding units 320 of FIG. 3 can decode the data unit using one or more layers of the decoding matrix, such as the decoding matrix 200 of FIG. 2. At block 710, the process 700 performs another layer decoding operation of decoding the data unit. For instance, the decoding units 320 can again decode the data unit using one or more next consecutive layers of the decoding matrix 200.

Substantially in parallel to the actions at block 710, the process 700 determines whether a parity check equation is satisfied at block 715. For example, the parity check module 410 can determine whether the decoded data unit and one or more layers of the decoding matrix satisfy a parity check equation. If the parity check equation is not satisfied, the process 700 sets the counter to zero and continues decoding the data unit at block 720. On the other hand, if the parity check equation is satisfied, the process 700 moves to block 725 and determines whether the counter equals zero. If the counter equals zero, the process 700 moves to block 740 and increments the counter. If the counter does not equals zero, the process 700 determines at block 730 whether the decoded data unit changed from a previous layer decoding operation. For example, the data compare module 430 can compare the decoded data unit to the decoded data unit from the previous layer decoding operation. If the decoded data unit did change, the process 700 moves to block 735 and sets the counter to one and continues decoding of the data unit. If the decoded data unit did not change, the process 700 moves to block 740 and increments the counter.

At block 745, the process 700 determines whether the counter exceeds a threshold. The data compare module 430, for instance, can compare the counter and the threshold to determine whether the counter exceeds the threshold. The threshold can depend on a number of layers of the decoding matrix or a degree of certainty desired before terminating decoding of the data unit, among other factors. For example, if the decoding matrix has five layers, the threshold can be set to the number of decoding matrix layers minus one (i.e., four in this example) such that the parity check and the change in decoded data unit conditions are satisfied consecutively for the five layers of the decoding matrix during early termination detection. As another example, if the decoding matrix has four layers, the threshold can be set to the number of decoding matrix layers minus two (i.e., two in this example) such that decoding has been successfully completed with a certain degree of certainty (e.g., 50%, 75%, 90%, 99%, or 99.99% confidence, or the like). If the counter does not exceed the threshold, the process 700 moves to block 750 and continues decoding of the data unit. If the counter does exceed the threshold, the process 700 moves to block 755 and terminates decoding of the data unit.

At block 760, the process 700 determines whether a maximum number of iterations has been reached, such as a maximum number of layer decoding operations or decoding iterations for the data unit. If the maximum number of iterations has been reached, at block 755, the process 700 terminates decoding of the data unit. On the other hand, if the maximum number of decoding iterations has not been reached, the process 700 moves to blocks 710 and 715 and performs the actions of blocks 710 and 715 substantially in parallel. At block 710, the process 700 again performs another layer decoding operation of decoding the data unit. At block 715, the process 700 again determines whether the parity check equation is satisfied; however, the process 700 now determines whether the parity check equation is satisfied based on the decoded data unit from the previous another layer decoding operation of decoding the data unit at block 710.

### Other Early Decoding Termination Detection Embodiments

FIG. 8 illustrates a block diagram of an early detection module 350 according to one embodiment of the invention. The early detection module 350 of FIG. 8 can include the same components as the early detection module 350 of FIG. 4 (where the parity check module 410 is a parity check module 410A) except that the early detection module 350 of FIG. 8 further includes a parity check module Z 410z. The parity check module Z 410z can advantageously enable termination of decoding of a data unit one layer decoding operation before the early detection module 350 of FIG. 4.

The parity check module Z 410z can receive decoded data from the rotate-left/right shifter 330 via the optional connection illustrated between the rotate-left/right shifter 330 and the early detection module 350 in FIG. 3. Since the decoded data from the rotate-left/right shifter 330 can be diagonal-aligned for a next layer sub-matrix of the decoding matrix, the parity check module Z 410z can perform a parity check, using a parity check equation such as Equation 4, for a next consecutive layer of the decoding matrix.

For example, substantially in parallel for a current layer decoding operation, the parity check module A 410a can determine whether C_{(i,1)}·H₁^{T}=0, and the parity check module Z 410z can determine whether C_{(i,1)}·H₂^{T}=0, where C_{(i,1)} refers to a decoded data unit from the current layer decoding operation and Hₙ refers to the nth layer of the decoding matrix. Substantially in parallel for a next consecutive layer decoding operation, the parity check module A 410a can determine whether C_{(i,2)}·H₂^{T}=0, the parity check module Z 410z can determine whether C_{(i,2)}·H₃^{T}=0, and the data compare module 430 can determine whether C_{(i,1)}=C_{(i,2)} where C_{(i,2)} refers to a decoded data unit from the next consecutive layer decoding operation. Substantially in parallel for a following consecutive layer decoding operation, the parity check module A 410a can determine whether C_{(i,3)}·H₃^{T}=0, the parity check module Z 410z can determine whether C_{(i,3)}·H₄^{T}=0, and the data compare module 430 can determine whether C_{(i,2)}=C_{(i,3)}, where C_{(i,3)} refers to a decoded data unit from the following consecutive layer decoding operation.

This process can continue until early termination detection conditions are satisfied, such as, for instance, that (1) a parity check is satisfied for x number of layers and (2) a decoded data unit remains unchanged for x-2 consecutive layer decoding operations, where x is the total number of layers of a decoding matrix. In the example of the previous paragraph, if all of the stated determinations by the parity check module A 410a, the parity check module Z 410z, and the data compare module 430 are satisfied, the early detection module 350 can terminate decoding of the data unit for a decoding matrix having four layers. Moreover, although the example of the previous paragraph illustrates that parity checks are performed for the same iteration of decoding the data unit, the early detection module 350 of FIG. 8 may further perform determinations for layer decoding operations from different iterations of decoding the data unit.

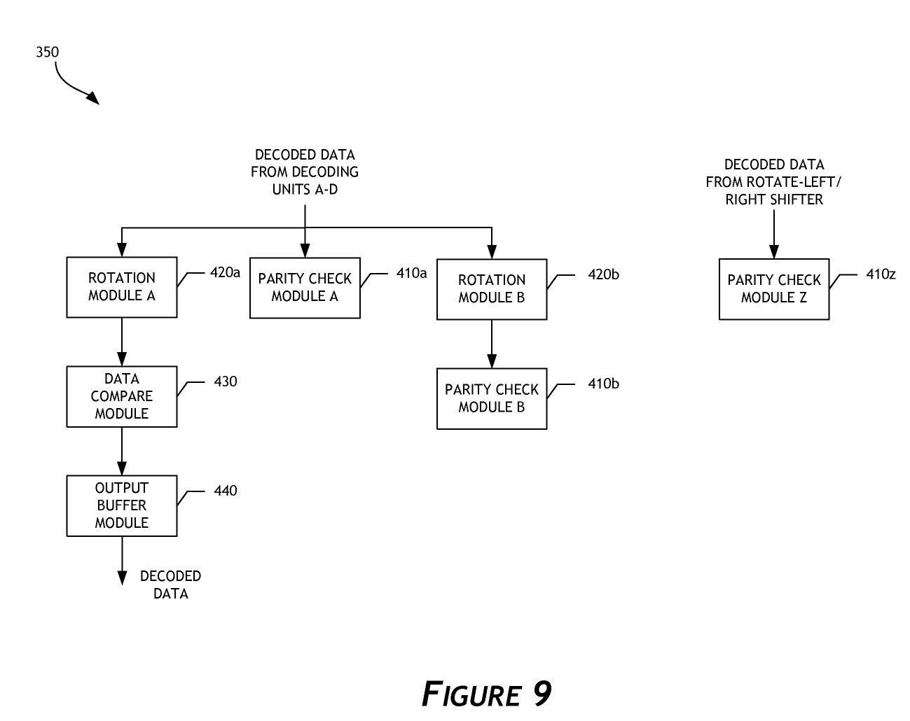

FIG. 9 illustrates a block diagram of an early detection module 350 according to one embodiment of the invention. The early detection module 350 of FIG. 9 can include the same components as the early detection module 350 of FIG. 8 (where the rotation module 420 is a rotation module 420A) except that the early detection module 350 of FIG. 9 further includes a rotation module B 420b and a parity check module B 410b. The rotation module B 420b and the parity check module B 410b can advantageously enable termination of decoding of a data unit one layer decoding operation before the early detection module 350 of FIG. 8.

The rotation module 420b can function similarly to the rotation module 420a. The rotation module 420b can receive decoded data from the decoding units 320 of FIG. 3. Since the portions of the decoded data received by the rotation module 420 may be rotated in an order based on a particular layer of decoding with the decoding matrix, the rotation module 420, under the control of the shift control module 340, can rotate or align the received data portions for evaluation by the parity check module B 410b.

The parity check module B 410b can function similarly to the parity check module A 410a and the parity check module Z 410z. The parity check module B 410b can perform a parity check equation, using a parity check equations such as Equation 4, for a following consecutive layer of the decoding matrix.

For example, substantially in parallel for a current layer decoding operation, the parity check module A 410a can determine whether C_{(i,1)}·H₁^{T}=0, the parity check module Z 410z can determine whether C_{(i,1)}·H₂^{T}=0, and the parity check module B 410b can determine whether C_{(i,1)}·H₃^{T}=0, where C_{(i,1)} refers to a decoded data unit from the current layer decoding operation and Hₙ refers to the nth layer of the decoding matrix. Substantially in parallel for a next consecutive layer decoding operation, the parity check module A 410a can determine whether C_{(i,2)}·H₂^{T}=0, the parity check module Z 410z can determine whether C_{(i,2)}·H₃^{T}=0, the parity check module B 410a can determine whether C_{(i,2)}·H₄^{T}=0, and the data compare module 430 can determine whether C_{(i,1)}=C_{(i,2)} where C_{(i,2)} refers to a decoded data unit from the next consecutive layer decoding operation.

This process can continue until early termination detection conditions are satisfied, such as, for instance, that (1) a parity check is satisfied for x number of layers and (2) a decoded data unit remains unchanged for x-3 consecutive layer decoding operations, where x is the total number of layers of a decoding matrix. In the example of the previous paragraph, if all of the stated determinations by the parity check module A 410a, the parity check module Z 410z, the parity check module B 410b, and the data compare module 430 are satisfied, the early detection module 350 can terminate decoding of the data unit for a decoding matrix having four layers. Moreover, although the example of the previous paragraph illustrates that parity checks are performed for the same iteration of decoding the data unit, the early detection module 350 of FIG. 9 may further perform determinations for layer decoding operations from different iterations of decoding the data unit.

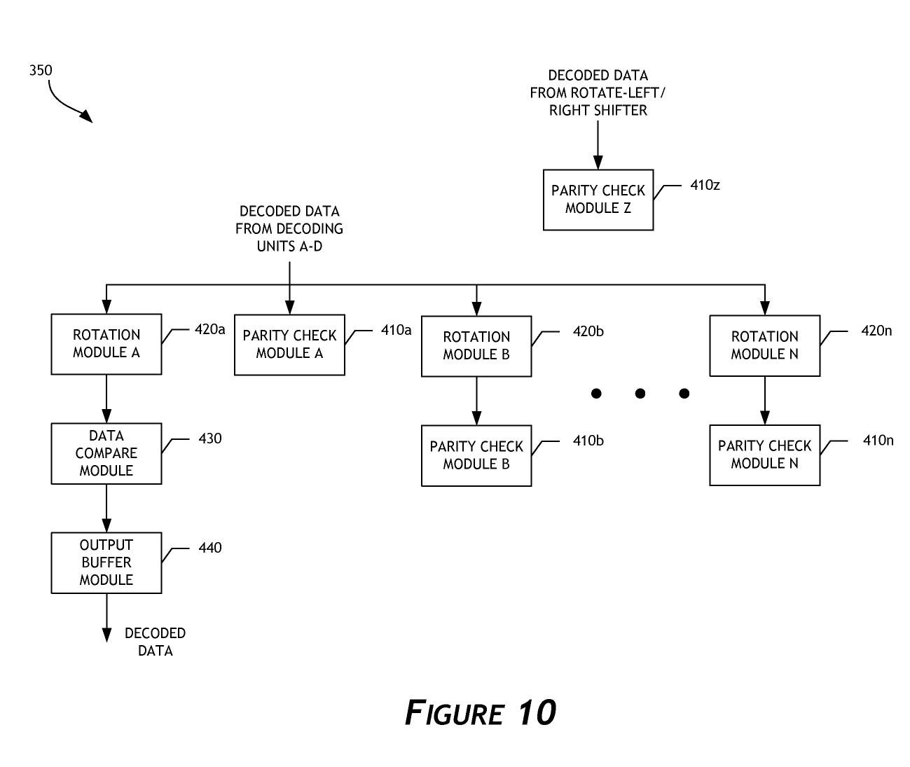

FIG. 10 illustrates a block diagram of an early detection module 350 according to one embodiment of the invention. The early detection module 350 of FIG. 10 can include the same components as the early detection module 350 of FIG. 9 except that the early detection module 350 of FIG. 10 further includes one or more rotation modules and parity check modules, such as a rotation module N 420n and a parity check module N 410n. The one or more additional rotation modules and parity check modules can function similarly to the rotation module B 420b and the parity check module B 410b, respectively, and advantageously enable termination of decoding of a data unit one or more layer decoding operations before the early detection module 350 of FIG. 9.

### Other Variations

Those skilled in the art will appreciate that in some embodiments, other suitable error correction mechanisms can be used in addition to and/or in place of LDPC coding. For example, Hamming coding, turbo coding, BCH coding, and the like can be used. Further, any suitable unit or grouping of data, such as octet, nibble, word, byte, etc., can be used in addition to or in place of a bit of user data. Moreover, the actual steps taken in the disclosed processes, such as the processes illustrated in FIGS. 5 and 7, may differ from those shown in the Figures. Additional system components can be utilized, and disclosed system components can be combined or omitted. Depending on the embodiment, certain of the steps described above may be removed, others may be added.

While certain embodiments have been described, these embodiments have been presented by way of example only, and are not intended to limit the scope of the protection. Indeed, the novel methods and systems described herein may be embodied in a variety of other forms. Furthermore, various omissions, substitutions and changes in the form of the methods and systems described herein may be made without departing from the spirit of the protection. The accompanying claims and their equivalents are intended to cover such forms or modifications as would fall within the scope and spirit of the protection. For example, the various components illustrated in the figures may be implemented as software and/or firmware on a processor, ASIC/FPGA, or dedicated hardware. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A solid-state storage system, comprising:
a non-volatile solid-state memory array configured to store a plurality of data units; and
a controller configured to:
iteratively decode a data unit using a coding matrix comprising a plurality of layers including a first layer and a second layer, an iteration of decoding comprising a plurality of layer decoding operations, the data unit read from the memory array, and
terminate decoding the data unit in response to determining that
the decoded data unit from a first layer decoding operation and the first layer satisfy a parity check equation,
the decoded data unit from a second layer decoding operation and the second layer satisfy the parity check equation, and
the decoded data unit from the first layer decoding operation and the decoded data unit from the second layer decoding operation are the same,
wherein the termination of decoding of the data unit reduces a number of layer decoding operations performed to decode the data unit.

2. The solid-state storage system of claim 1, wherein the first layer decoding operation and the second layer decoding operation are consecutively performed layer decoding operations.

3. The solid-state storage system of claim 2, wherein the first layer decoding operation and the second layer decoding operation are layer decoding operations from different iterations of decoding the data unit.

4. The solid-state storage system of claim 1, wherein the first layer decoding operation corresponds to when the first layer is used to decode the data unit, and the second layer decoding operation corresponds to when the second layer is used to decode the data unit.

5. The solid-state storage system of claim 1, wherein the controller is further configured to determine whether the decoded data unit from the first layer decoding operation and a third layer of the plurality of layers satisfy the parity check equation.

6. The solid-state storage system of claim 1, wherein the controller is further configured to:
determine whether the decoded data unit from a third layer decoding operation and a third layer of the plurality of layers satisfy the parity check equation, and
determine whether the decoded data unit from the second layer decoding operation and the decoded data unit from the third layer decoding operation are the same.

7. The solid-state storage system of claim 1, wherein the controller is further configured to maintain a count of a number of consecutive times that both
the decoded data unit from a layer decoding operation and one or more layers of the plurality of layers satisfy the parity check equation, and
the decoded data unit from the layer decoding operation and the decoded data unit from a previous consecutive layer decoding operation are the same.

8. The solid-state storage system of claim 7, wherein before the controller terminates decoding the data unit, the controller is further configured to compare the count to a threshold.

9. The solid-state storage system of claim 1, wherein the parity check equation comprises a matrix multiplication of the decoded data unit from one layer decoding operation and a transpose of one layer of the plurality of layers, the decoded data unit from the one layer decoding operation and the transpose of the one layer satisfying the parity check equation when a result of the matrix multiplication is zero.

10. The solid-state storage system of claim 1, wherein the data unit comprises low-density parity-check (LDPC) data units, and the coding matrix comprises a plurality of sub-matrixes, the plurality of sub-matrixes comprising identity matrixes rotated by values.

11. In a data storage system, a method of decoding data, the method comprising:
iteratively decoding a data unit using a coding matrix comprising a plurality of layers including a first layer and a second layer, an iteration of decoding comprising a plurality of layer decoding operations, the data unit read from a non-volatile solid-state memory array; and
terminating decoding the data unit in response to determining that
the decoded data unit from a first layer decoding operation and the first layer satisfy a parity check equation,
the decoded data unit from a second layer decoding operation and the second layer satisfy the parity check equation, and
the decoded data unit from the first layer decoding operation and the decoded data unit from the second layer decoding operation are the same.

12. The method of claim 11, wherein the first layer decoding operation and the second layer decoding operation are consecutively performed layer decoding operations.

13. The method of claim 12, wherein the first layer decoding operation and the second layer decoding operation are layer decoding operations from different iterations of decoding the data unit.

14. The method of claim 11, wherein the first layer decoding operation corresponds to when the first layer is used to decode the data unit, and the second layer decoding operation corresponds to when the second layer is used to decode the data unit.

15. The method of claim 11, further comprising determining whether the decoded data unit from the first layer decoding operation and a third layer of the plurality of layers satisfy the parity check equation.

16. The method of claim 11, further comprising:
determining whether the decoded data unit from a third layer decoding operation and a third layer of the plurality of layers satisfy the parity check equation, and
determining whether the decoded data unit from the second layer decoding operation and the decoded data unit from the third layer decoding operation are the same.

17. The method of claim 11, further comprising maintaining a count of a number of consecutive times that both
the decoded data unit from a layer decoding operation and one or more layers of the plurality of layers satisfy the parity check equation, and
the decoded data unit from the layer decoding operation and the decoded data unit from a previous consecutive layer decoding operation are the same.

18. The method of claim 17, further comprising before terminating decoding the data unit, comparing the count to a threshold.

19. The method of claim 11, wherein the parity check equation comprises a matrix multiplication of the decoded data unit from one layer decoding operation and a transpose of one layer of the plurality of layers, the decoded data unit from the one layer decoding operation and the transpose of the one layer satisfying the parity check equation when a result of the matrix multiplication is zero.

20. The method of claim 11, wherein the data unit comprises low-density parity-check (LDPC) data units, and the coding matrix comprises a plurality of sub-matrixes, the plurality of sub-matrixes comprising identity matrixes rotated by values.

21. The method of claim 11, wherein the data storage system comprises a controller, and wherein the method is performed by the controller.
